(19) United States
(12) Patent Application Publication
(10) Pub. No.: US 2024/0037476 A1
(43) Pub. Date: Feb. 1, 2024

(54) ADVISOR RISK SCORE

(71) Applicant: Ameriprise Financial, Inc., Minneapolis, MN (US)

(72) Inventors: VIPUL D. SAHNI, Noida (IN); SAURABH KUMAR, Gurugram (IN); CHRIS SHERLOCK, Minneapolis, MN (US); ROBERT MACKINNON, Minneapolis, MN (US)

(73) Assignee: Ameriprise Financial, Inc., Minneapolis, MN (US)

(21) Appl. No.: 18/122,548

(22) Filed: Mar. 16, 2023

(30) Foreign Application Priority Data
Jul. 30, 2022 (IN) 202211043745

(51) Int. Cl. G06Q 10/0635

(52) U.S. Cl. CPC G06Q 10/0635

(57) ABSTRACT

The disclosure may include an exemplary method comprising receiving risk metric data from a plurality of data sources; determining if the risk metric data passes quality control requirements; factoring the risk metric data; weighting the risk metric data by multiplying the weights at a sub-metric level; standardizing the risk metric data by scaling each risk value in the risk metric data to a range of values for each advisor to obtain standardized risk values; prioritizing the risk metric data by assigning a metric weight to the standardized risk values; further prioritizing the risk metric data by assigning a category weight to the standardized risk values; aggregating the risk metric data for an advisor to create advisor risk metric data; scoring a risk associated with the advisor based on the advisor risk metric data; and transferring the advisor risk data to a dashboard.

### CROSS-REFERENCE TO RELATED APPLICATIONS

This application claims priority to, and the benefit of, India Patent Application No. 202211043745, filed Jul. 30, 2022 and titled “ADVISOR RISK SCORE,” which is incorporated by reference herein in its entirety for all purposes FIELD

This disclosure generally relates to risk scoring, and more particularly, to using risk metric data to determine a risk associated with an advisor.

### BACKGROUND

Some financial advising companies may have over 10,000 financial advisors under management, so analyzing risk factors for each of the financial advisors may take over 10,000 hours each year. Such financial advisors often work in an environment with various risk factors. The risk factors may include, for example, regulatory risk, legal risk, operational risk, reputational risk, managerial risk and other risks. The extent and severity of such risks may vary depending on the volume of transactions, the hiring of new advisors, outside business activities, new financial products, the suitability of the product for the investor, referral sources, remote workers, commissions, incentive programs, proprietary products, fee-based accounts, non-cash compensation, gifts, gratuities, customer identification issues, money laundering issues, the geographic extent of the investments, the retention of electronic communications and documents, the use of the internet and the use of other technologies and devices.

To help manage such risks, surveillance and compliance teams typically utilized multiple reports that flagged financial advisor risk. The reports were usually from a variety of segments such as, for example, referrals, discipline, heightened supervision, complaints, investigations, etc. The surveillance and compliance teams reviewed the multiple reports to hopefully get a holistic view of the advisor's overall risk based on a variety of factors. However, the surveillance and compliance teams often found that navigating through the different reports was a time-consuming process and the review did not provide the desired holistic risk preview of an individual advisor. If the advisor problems were not fully discovered or properly addressed, the company risked potentially missing out on discovering the problems, particularly while taking excessive time to collate through so many data points from diverse sources. The company also would experience risk judgement errors caused by compiling non-standardized data points.

### SUMMARY

The disclosure includes, in various embodiments and as set forth in FIG. 1, an exemplary method comprising receiving, by a processor, risk metric data from a plurality of data sources (step 105); determining, by the processor, if the risk metric data passes quality control requirements (step 110); factoring, by the processor, the risk metric data, wherein the factoring includes combining factors of risk values within a metric to output one risk value per advisor per metric (step 115); weighting, by the processor, the risk metric data by multiplying the weights at a sub-metric level (step 120); standardizing, by the processor, the risk metric data by scaling each risk value in the risk metric data to a range of values for each advisor to obtain standardized risk values (step 125); prioritizing, by the processor, the risk metric data by assigning a metric weight to the standardized risk values (step 130); further prioritizing, by the processor, the risk metric data by assigning a category weight to the standardized risk values (step 135); aggregating, by the processor, the risk metric data for an advisor to create advisor risk metric data (step 140); scoring, by the processor, a risk associated with the advisor based on the advisor risk metric data (step 145); and transferring, by the processor, the advisor risk data to a dashboard in a front-end system (step 150).

The method may further comprise receiving, by the processor, a U4 Disclosures summary for the advisor as part of the risk metric data. The scoring may include scoring a U4 Disclosures summary of the advisor. The method may further comprise creating, by the processor, risk trends based on the risk metric data. The method may further comprise creating, by the processor, at least one of charts or graphs based on the risk metric data. The plurality of data sources may include at least one of an Excel file, an analytics database (e.g., SAS DataMart that contains processed data in the form of an SAS dataset), a consequence management database and/or an RDMS (Relational Database Management System). The data sources may include input from a supervision unit (e.g., in an Excel file) that supervises transactions and processes for the brokers in the field. The determining if the risk metric data passes quality control requirements may include using Statistical Analysis System (SAS) programs. The quality control requirements may include checking for at least one of data types, column names, distinct advisor numbers or text formats. The quality control requirements may include checking for data types, and wherein the data types include at least one of surveillance referrals, complaints, investigations, supervision or advisor financial distress indicators.

The risk metric data may include at least one of customer complaints, disciplinary actions, U4 Disclosures history, heightened supervision, realized losses, early individual retirement account (IRA) withdrawals, loan details, netflows, surveillance referrals, distance from a RP (registered principal that is a licensed securities dealer empowered to oversee operational, compliance, trading, and/or sales personnel), client to staff ratio, education notices, declining gross dealer concession (GDC), low assets, bounced checks, outside business activities, recently divorced, solo practitioner, trade corrections or compliance determination.

The risk sub-metric data may include at least one of SPS appropriateness, annuity replacements, c-share flipping, justified sales practice complaint or investigation, partially justified sales practice complaint, unjustified sales practice complaint, annuity team education, trending heightened supervision (TH&S) education, annuity team discipline, negative net flows, bounced checks, low GDC or declined GDC.

The method may further comprise storing, by the processor, the risk metric data in a server directory as SAS datasets. The factoring may include combining a number of complaints and a settlement amount. The factoring may include combining assets in dollars with years of experience. The weighting may include assigning a higher risk to a justified complaint. The weighting may include assigning a lower risk to an unjustified complaint. The risk metric data may be part of risk categories comprising at least one of risk category, risk metric or the risk sub-metric. The assigning the metric weight to the standardized risk values may include multiplying the standardized risk values by the metric weight. The assigning the category weight to the standardized risk values may include multiplying the standardized risk values by the category weight. The range of values may be between 0.1 and 1.1. The method may further comprise creating, by the processor, an error code, in response to the risk metric data failing the quality control requirements.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and:

FIG. 1 is an exemplary flow chart of the process for receiving the risk metric data, processing the data and scoring a risk, in accordance with various embodiments.

FIG. 2 is an exemplary dashboard showing the different charts and graphs showing the risk data in different formats, in accordance with various embodiments.

### DETAILED DESCRIPTION

In general, the system uses risk metric data to determine a risk associated with an advisor. The system is an interactive, dynamic and holistic risk assessment tool. The system provides a one-stop dashboard to analyze advisor risk issues, to identify risk severity, to facilitate creating efficiencies in risk information management and to allow for deep insights into risk criteria to enable judgments at a granular level. The dashboard may allow the user to drill down from high-level to low-level information. Different functions of the system may be embodied as software, hardware, an app, a dashboard and/or a platform. The system may be platform independent, scalable and may plug into various resources. In various embodiments, the system may summarize risks for any number of advisors and incorporate any number of risk data feeds, along with the flexibility of adding additional risk parameters. For example, the system may use over 20 risk data feeds and summarize risks for an organization having over 10,000 advisors. The system may include remote access to data, standardizing data that was input (and received from a risk data feed) in non-standardized forms or formats, generating a message when updated information is stored, transmitting the message to various users and allowing remote users to share information in real time. The system may utilize the raw data and/or processed data to create risk trends or charts/graphs about the risk factors. The system may use artificial intelligence or machine learning to determine trends and provide suggestions for mitigating certain risks. The system may also refer certain advisors or risk factors for manual analysis or intervention. While this disclosure may use the term “advisor” and provide examples of a financial advisor with surveillance, field office and finance teams, the system may be utilized for any employee, contractor, personnel, administrator, executive, etc. in any industry or organization.

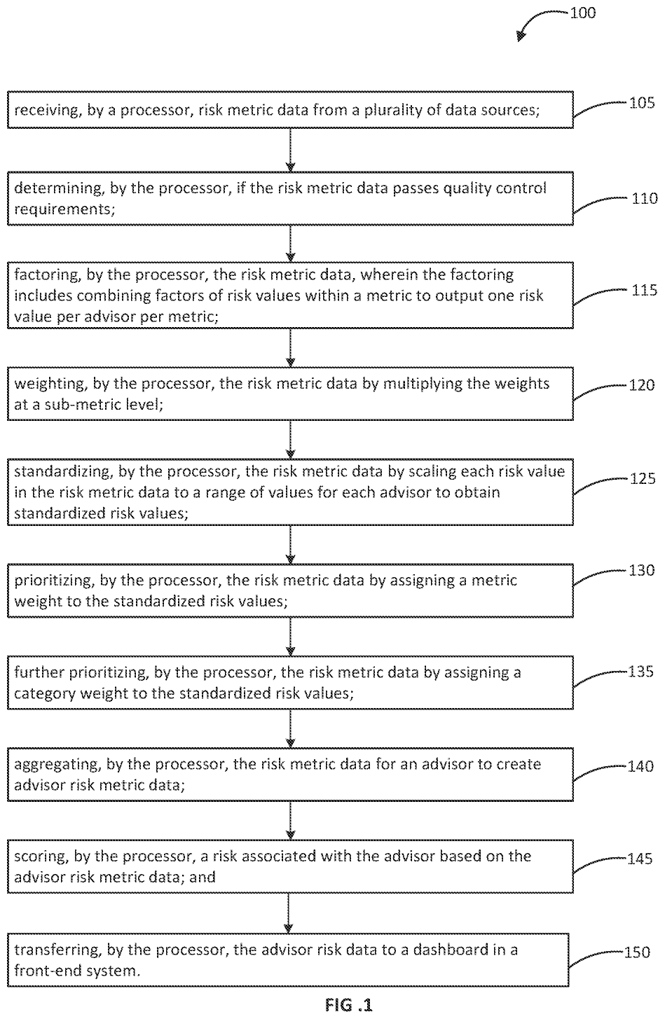

In various embodiments, and as shown in FIG. 1, the system may receive risk metric data from a plurality of data sources. The plurality of data sources may include at least one of an Excel file, an analytics database (e.g., SAS DataMart that contains processed data in the form of an SAS dataset), a consequence management database and/or an RDMS database. The data sources may include input from a supervision unit (e.g., in an Excel file) that supervises transactions and processes for the brokers in the field. The risk metric data may also include parts of FINRA's risk scoring framework by scoring an advisor's U4 Disclosures summary. As such, the system may receive a U4 Disclosures summary for the advisor as part of the risk metric data. The scoring may include scoring a U4 Disclosures summary of the advisor. The Form U4 (Uniform Application for Securities Industry Registration or Transfer) is used to establish a registration. FINRA, other self-regulatory organizations (SROs) and jurisdictions typically use the Form U4 to elicit employment history, disciplinary and other information about individuals to register them.

In various embodiments, the risk metric data may be part of risk categories comprising at least one of a risk category, risk metric or a risk sub-metric. As used herein, the terms risk category, risk metric and risk sub-metric may be used interchangeably, and the data or factors associated with each phrase may be used interchangeably. The risk metric data may include data related to any type of risk, issue, concern, process, system, etc. For example, the risk metric data may include customer complaints, disciplinary actions, U4 Disclosures history, heightened supervision, realized losses, early individual retirement account (IRA) withdrawals, loan details, netflows, surveillance referrals, distance from RP, client to staff ratio, education notices, declining GDC, low assets, bounced checks, outside business activities, recently divorced, solo practitioner, trade corrections and/or compliance determination.

If an advisor has a high number of complaints, then the advisor may be considered of high regulatory risk. If an advisor has high number of past disclosures (e.g., EAR and U4 Disclosures), then the advisor may be considered of high regulatory risk. If the surveillance team has referred the advisor a high number of times, then the advisor may be considered of high regulatory risk. If the advisor has a high negative NetFlow, then the advisor may be considered to have financial distress and high regulatory risk. If the advisor has early individual retirement account (IRA) withdrawals, then the advisor may be considered to have financial distress and high regulatory risk. If the advisor has high realized losses, then the advisor may be considered to have financial distress and high regulatory risk. If the advisor has a high number of bounced checks, then the advisor may be considered to have financial distress and high regulatory risk. If the advisor has declining GDC, then the advisor may be considered to have financial distress and high regulatory risk. If the advisor is recently divorced, then the advisor may be considered to have financial distress and high regulatory risk. If the advisor has low assets, then the advisor may be considered to have financial distress and high regulatory risk. If the advisor has high loan details, then the advisor may be considered to have financial distress and high regulatory risk. If the advisor has outside business activities (OBA), then the advisor may be considered to have supervisory risk. If the advisor has a high number of education notices, then the advisor may be considered to have supervisory risk. If the advisor has a high number of disciplinary actions, then the advisor may be considered to have supervisory risk. If the advisor has a high number of trade corrections, then the advisor may be considered to have supervisory risk. If the advisor is put on heightened supervision, then the advisor may be considered to have high regulatory risk. If the advisor is a solo practitioner, then the advisor may have less time for all the clients, so the advisor may be considered to have environmental risk. If the advisor's distance form RP is more than a certain distance, then the advisor may be considered to have environmental risk. If the client to staff ratio for the advisor is high, then the advisor has less time to take care of all his clients, so the advisor may be considered to have environmental risk.

The risk sub-metric data may further include SPS appropriateness, annuity replacements, c-share flipping, justified sales practice complaint or investigation, partially justified sales practice complaint, unjustified sales practice complaint, annuity team education, TH&S education, annuity team discipline, negative net flows, bounced checks, low GDC and/or declined GDC. GDC may be a basis for a field compensation program. GDC may be the money (concession) paid by the product manufacturer (vendor) to the distributor (broker-dealer). The representative (advisor) making the sale may receive a percentage of the concession (payout). The sub-metrics of SPS appropriateness, annuity replacements and c-share flipping may include metrics based on surveillance referrals. The sub-metrics of justified sales practice complaint or investigation, partially justified sales practice complaint, and unjustified sales practice complaint may include metrics based on C&I (Complaints and Investigations). The sub-metrics of annuity team education and TH&S education may include metrics based on education. The sub-metrics of annuity team discipline, negative net flows, bounced checks, low GDC and/or declined GDC may include metrics based on discipline.

In various embodiments, the system may determine if the risk metric data passes quality control requirements. The determining if the risk metric data passes quality control requirements may include using Statistical Analysis System (SAS) programs. SAS is a statistical software suite developed by the SAS Institute for data management, advanced analytics, multivariate analysis, business intelligence, criminal investigation, and predictive analytics. The quality control requirements may include checking for at least one of data types, column names, distinct advisor numbers or text formats. The data types may include surveillance referrals, complaints, investigations, supervision and/or advisor financial distress indicators. In various embodiments, the method may further comprise creating an error code, in response to the risk metric data failing the quality control requirements. In various embodiments, the method may further comprise storing the risk metric data in any database such as, for example, a server directory as Statistical Analysis System (SAS) datasets.

In various embodiments, the system may factor the risk metric data using any factoring method. The factoring may include, for example, combining factors of risk values within a metric to output one risk value per advisor per metric. The factoring may include combining a number of complaints and a settlement amount. The factoring may include combining assets in dollars with years of experience.

In various embodiments, the system may weight the risk metric data using any weighting method. The weighting method may include multiplying the weights at a sub-metric level. The weighting may include assigning a higher risk to a justified complaint. The weighting may include assigning a lower risk to an unjustified complaint. In various embodiments, the system may include standardizing the risk metric data using any standardizing method. The standardizing may include scaling each risk value in the risk metric data to a range of values for each advisor to obtain standardized risk values. An exemplary range of values may be between 0.1 and 1.1. The system may standardize the values to 0 and 1, then add 0.1 (so the that assigned value is not equal to 0). The standardization uses the formula Z=(x-m)/s, where x is the original value; m is the mean of distribution and s is the standard deviation.

In various embodiments, the system may prioritize the risk metric data using any prioritizing method. The prioritizing may include assigning a metric weight to the standardized risk values. The metric weight may be a subjective amount based on the type of metrics in question. The metric weight may be determined by discussing the appropriate metrics with stakeholders and business partners. The assigning the metric weight to the standardized risk values may include multiplying the standardized risk values by the metric weight. The system may further prioritize the risk metric data by assigning a category weight to the standardized risk values. The category weight may be a subjective amount based on the type of metrics in question. The category weight may be determined by discussing the appropriate metrics with stakeholders and business partners. The assigning the category weight to the standardized risk values may include multiplying the standardized risk values by the category weight. In various embodiments, the system may aggregate the risk metric data for an advisor to create advisor risk metric data. In various embodiments, the system may score a risk associated with the advisor based on the advisor risk metric data.

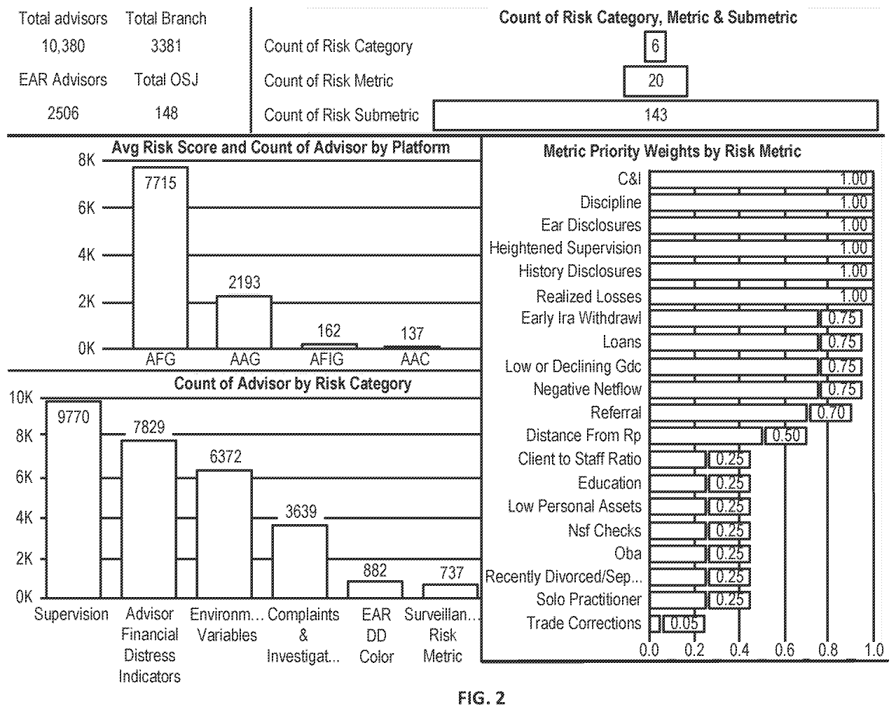

In various embodiments, the system may transfer the advisor risk data to a dashboard. The dashboard may be part of a front-end system. The system may create risk trends based on the risk metric data. The system may also create charts and/or graphs based on the risk metric data. The risk trends, charts and/or graphs may be included in the dashboard. In various embodiments, and with reference to FIG. 2, the dashboard may be set to display data over any timeframe (e.g., 24 months). The dashboard may include different field views for different groupings, types or levels of advisors. For example, the field views may include different groupings of data based on advisor view, branch view or an Office of Supervisory Jurisdiction (OSJ) view. An OSJ may be an office identified by the broker dealer as having supervisory responsibilities for agents and branch offices within its region. The OSJ may have final approval of new accounts, and retail communication. The OSJ may also make market or structure offerings. The dashboard may include general data about the total number of advisors, total branches, experienced advisor recruits (EAR) and total OSJ (e.g., values summarized at the OSJ review). The dashboard may include the count of risk categories, risk metrics and risk sub-metrics used in the analysis. The dashboard may also include graphs showing the average risk score and count of advisors by platform. The platforms may include, for example, the advisors that are employees of a financial advisor company (e.g., Ameriprise Financial Advisors), advisors that provide advice over the phone, advisors that work with financial institution partners, the non-employee franchise advisors that may use a brand name of a financial advisor company (e.g., Ameriprise Franchise Group) and/or independent advisors. The dashboard may further include a count of advisors by risk category. The risk categories may include, for example, supervision, advisor financial distress indicators, environmental variables, complaints & investigations, EAR status or color and surveillance risk metrics. The EAR status may include a color of determination, wherein before an experienced advisor recruit is hired, the EAR may be given a color (e.g., yellow, green, etc.) based on his past disclosures. The dashboard may additionally include the metric priority weights by risk metric. In various embodiments, the risk metrics may include, for example, C&I, discipline, EAR disclosures, heightened supervision, history disclosures (e.g., U4 Disclosures), realized loses, early IRA withdrawals, loans, low or declining GDC, negative netflow, referral, distance from RP, client to staff ratio, education, low personal assets, NSF checks, outside business activities (OBA), recently divorced/separated, solo practitioner and trade corrections.

The following are examples of the process. Out of a total of six risk categories, this exemplary advisor may fall under 5 categories. In Category 1, the risk category is advisor financial distress indicators, the risk metric is low personal assets, and the risk sub-metric is adv average asset value. For factorization, in this sub-metric, this Advisor has $4103.49 in total asset and has total experience of 20 years with ORIGINAL_RISK_VAL_1=4103.49 and ORIGINAL_RISK_VAL_2=20. The system ranks both the original risk values and combines them to calculate the F_SCORE for this metric as F_SCORE: 4797. After factorization, the system multiplies the weight at sub-metric level, wherein SUB-METRIC_WEIGHT=1 and P_S_SCORE=SUB-METRIC_WEIGHT*F_SCORE=1*4797=4797. For standardization, the system scales every value between 0.1-1.1 per advisor per metric such that S_M_SCORE=0.837922801. For prioritization, and after standardization, the system multiplies the Risk Metric weights to standardized value such that METRIC_WEIGHT=0.25 and P_S_M_SCORE=METRIC_WEIGHT*S_M_SCORE=0.25*0.837922801=0.2094807. For category score, the system multiplies the prioritized summarized score to the weight of the Risk Category, such that CATEGORY_WEIGHT=5.5 and C_SCORE=CATEGORY_WEIGHT*P_S_M_SCORE=5.5*0.2094807=1.152143852.

In Category 2, the risk category is complaints & investigations, the risk metric is c&i and the risk sub-metric is investigation request. For factorization, in this sub-metric, this Advisor has 1 Investigation Request C&I and Settlement amount=$359.49 such that ORIGINAL_RISK_VAL_1=1 and ORIGINAL_RISK_VAL_2=359.49. The system combines the original risk value 1 to a factor of the original risk value 2 such that F_SCORE: 1.000359. After Factorization, the system multiplies the weight at sub-metric level such that SUB-METRIC_WEIGHT=0.05 and P_S_SCORE=SUB-METRIC_WEIGHT*F_SCORE=0.05*1.000359=0.05001795. For standardization, the system scales every value between 0.1-1.1 per advisor per metric such that S_M_SCORE=0.10000408. For prioritization, after Standardization, the system multiplies the Risk Metric weights to standardized value such that METRIC_WEIGHT=1 and P_S_M_SCORE=METRIC_WEIGHT*S_M_SCORE=1*0.10000408. For category score, the system multiplies the prioritized summarized score to the weight of the Risk Category such that CATEGORY_WEIGHT=10 and C_SCORE=CATEGORY_WEIGHT*P_S_M_SCORE=10*0.10000408=1.000040795.

In Category 3, the advisor falls into two Risk Metrics (client to staff ratio and distance from RP). the risk category is environmental variables, the risk metric is client to staff ratio and the risk sub-metric is active client to active staff ratio. For Factorization, in this sub-metric, this Advisor has Client to Registered Staff Ratio of 280 such that ORIGINAL_RISK_VAL_1=280. For this metric, the F_SCORE is same as ORIGINAL_RISK_VAL_1 so F_SCORE: 280. After Factorization, the system multiplies the weight at sub-metric level such that SUB-METRIC_WEIGHT=1 and P_S_SCORE=SUB-METRIC_WEIGHT*F_SCORE=1*280=280. For Standardization, the system scales every value between 0.1-1.1 per advisor per metric such that S_M_SCORE=0.144256195. For Prioritization, and after Standardization, the system multiplies the Risk Metric weights to standardized value such that METRIC_WEIGHT=0.25 and P_S_M_SCORE=METRIC_WEIGHT*S_M_SCORE=0.25*0.144256195=0.036064049. For Category Score, the system multiplies the prioritized summarized score to the weight of the Risk Category such that CATEGORY_WEIGHT=1 and DISTRIBUTED_C_SCORE=CATEGORY_WEIGHT*P_S_M_SCORE=1*0.036064049=0.036064049.

The risk category is environmental variables, risk metric is distance from RP and risk sub-metric is RP distance greater than 300 and ratio of RP to advisor. For factorization, in this sub-metric, this Advisor's Average minimum distance from RP is Greater than 300 Mi and RP to Advisor Ratio is 0.023 such that ORIGINAL_RISK_VAL_1=1 and ORIGINAL_RISK_VAL_2=0.022644229. For this metric, the system ranks the original rank value in descending order and the rank is F_SCORE such that F_SCORE: 153.5. After factorization, the system multiplies the weight at sub-metric level such that SUB-METRIC_WEIGHT=1 and P_S_SCORE=SUB-METRIC_WEIGHT*F_SCORE=1*153.5=153.5. For standardization, the system scales every value between 0.1-1.1 per advisor per metric such that S_M_SCORE=0.355016722. For prioritization, and after standardization, the system multiplies the Risk Metric weights to standardized value such that METRIC_WEIGHT=0.5 and P_S_M_SCORE=METRIC_WEIGHT*S_M_SCORE=0.5*0.355016722=0.177508361. For category score, the system multiplies the prioritized summarized score to the weight of the Risk Category such that CATEGORY_WEIGHT=1 and DISTRIBUTED_C_SCORE=CATEGORY_WEIGHT*P_S_M_SCORE=1*0.177508361=0.177508361. For total category score, the system calculates the total category weight by adding the distributed category weights such that C_SCORE=DSTRB_P_C_SCORE (CLIENT TO STAFF RATIO)+DSTRB_P_C_SCORE (Distance From RP)=0.036064049+0.177508361=0.21357241.

In Category 4, the advisor falls into two Risk Metrics (Education and OBA) and under Education, the advisor falls under 4 Risk Sub-metrics. The risk category is SUPERVISION, the risk metric is EDUCATION and the risk sub-metric is DOCUMENTATION CLIENT SUITABILITY INCORRECT. For factorization, in this sub-metric, this Advisor has 4 Education for Documentation client suitability incorrect such that ORIGINAL_RISK_VAL_1=4. For this metric, the F_SCORE is same as ORIGINAL_RISK_VAL_1 such that F_SCORE: 4. After factorization, the system multiplies the weight at sub-metric level such that SUB-METRIC_WEIGHT=0.75 and P_S_SCORE=SUB-METRIC_WEIGHT*F_SCORE=0.75*4=3. For standardization, the system scales every value between 0.1-1.1 per advisor per metric such that S_M_SCORE=0.154744526. For prioritization, and after standardization, the system multiplies the Risk Metric weights to standardized value such that METRIC_WEIGHT=0.25 and P_S_M_SCORE=METRIC_WEIGHT*S_M_SCORE=0.25*0.154744526=0.038686131. for category score, the system multiplies the prioritized summarized score to the weight of the Risk Category such that CATEGORY_WEIGHT=8.5 and DSTRB_P_C_SCORE=CATEGORY_WEIGHT*P_S_M_SCORE=8.5*0.038686131=0.328832117.

The risk category is supervision, the risk metric is OBA and the risk sub-metric is L. For factorization, in this sub-metric, this Advisor has 2 OBA as L such that ORIGINAL_RISK_VAL_1=2. For this metric, the F_SCORE is same as ORIGINAL_RISK_VAL_1 such that F_SCORE: 2. After Factorization, the system multiplies the weight at sub-metric level such that SUB-METRIC_WEIGHT=0.25 and P_S_SCORE=SUB-METRIC_WEIGHT*F_SCORE=0.25*2=0.5. For standardization, the system scales every value between 0.1-1.1 per advisor per metric such that S_M_SCORE=0.111111111. For prioritization, and after standardization, the system multiplies the Risk Metric weights to standardized value such that METRIC_WEIGHT=0.25 and P_S_M_SCORE=METRIC_WEIGHT*S_M_SCORE=0.25*0.111111111=0.027777778. For category score, the system multiplies the prioritized summarized score to the weight of the Risk Category such that CATEGORY_WEIGHT=5.5 and DSTRB_P_C_SCORE=CATEGORY_WEIGHT*P_S_M_SCORE=5.5*0.027777778=0.152777778. For the total category score, the system calculates the total category weight by adding the distributed category weights such that C_SCORE=DSTRB_P_C_SCORE (EDUCATION)+DSTRB_P_C_SCORE (OBA)=+0.152777778=0.481609895.

For Category 5, the risk category is surveillance risk metric, the risk metric is referral and the risk sub-metric is order review—monthly. For factorization, in this sub-metric, this Advisor was referred for Order Review—Monthly such that ORIGINAL_RISK_VAL_1=1. For this metric, the F_SCORE is same as ORIGINAL_RISK_VAL_1 such that F_SCORE: 1. After factorization, the system multiplies the weight at sub-metric level such that SUB-METRIC_WEIGHT=0.75 and P_S_SCORE=SUB-METRIC_WEIGHT*F_SCORE=0.75*1=0.75. For standardization, the system scales every value between 0.1-1.1 per advisor per metric such that S_M_SCORE=0.3. For prioritization and after standardization, the system multiplies the Risk Metric weights to standardized value such that METRIC_WEIGHT=0.7 and P_S_M_SCORE=METRIC_WEIGHT*S_M_SCORE=0.7*0.3=0.21. For category score, the system multiplies the prioritized summarized score to the weight of the Risk Category such that CATEGORY_WEIGHT=3.5 and C_SCORE=CATEGORY_WEIGHT*P_S_M_SCORE=3.5*0.21=0.735. For Advisor Overall Score, after calculating the Individual Category Scores, the system adds the individual category scores to get the Advisor Overall Score such that ADVISOR OVERALL SCORE=C_SCORE (ADVISOR FINANCIAL DISTRESS INDICATORS)+C_SCORE (COMPLAINTS &INVESTIGATIONS)+C_SCORE (ENVIRONMENTAL VARIABLES)+C_SCORE (SUPERVISION)+C_SCORE (SURVEILLANCE RISK METRIC)=1.152143852+1.000040795+0.21357241++0.735=3.582366952.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not for purposes of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method known in the art.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC®, optical storage devices, magnetic storage devices, and/or the like.

In various embodiments, components, modules, and/or engines of the system may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPRERE® MQTM (formerly MQSeries) by IBM®, Inc. (Armonk, NY) is an example of a commercially available middleware product. An Enterprise Service Bus (“ESB”) application is another example of middleware.

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA® devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME®, and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, cross-over bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16-bit integers.

In various embodiments, the server may include application servers (e.g., WEB SPHERE®, WEBLOGIC®, JBOSS®, POSTGRES PLUS ADVANCED SERVER®, etc.). In various embodiments, the server may include web servers (e.g., Apache, IIS, GOOGLE® Web Server, SUN JAVA® System Web Server, JAVA® Virtual Machine running on LINUX® or WINDOWS® operating systems).

A web client includes any device or software which communicates via any network, such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE CHROME′ software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

The various system components may be independently, separately, or collectively suitably coupled to the network via data links which includes, for example, a connection to an Internet Service Provider (ISP) over the local loop as is typically used in connection with standard modem communication, cable modem, DISH NETWORK®, ISDN, Digital Subscriber Line (DSL), or various wireless communication methods. It is noted that the network may be implemented as other types of networks, such as an interactive television (ITV) network. Moreover, the system contemplates the use, sale, or distribution of any goods, services, or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

The computing unit of the web client may be further equipped with an internet browser connected to the internet or an intranet using standard dial-up, cable, DSL, or any other internet protocol known in the art. Transactions originating at a web client may pass through a firewall in order to prevent unauthorized access from users of other networks. Further, additional firewalls may be deployed between the varying components of CMS to further enhance security.

Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic curve cryptography (e.g., ECC, ECDH, ECDSA, etc.), and/or other post-quantum cryptography algorithms under development.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 ® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over conventional technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

Any communication, transmission, and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word or EXCEL, an ADOBE® Portable Document Format (PDF) document, etc.), an “ebook,” an “emagazine,” an application or microapplication (as described herein), an short message service (SMS) or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUIMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

1. A method comprising:
receiving, by a processor, risk metric data from a plurality of data sources;
determining, by the processor, if the risk metric data passes quality control requirements;
factoring, by the processor, the risk metric data, wherein the factoring includes combining factors of risk values within a metric to output one risk value per advisor per metric;
weighting, by the processor, the risk metric data by multiplying the weights at a sub-metric level;
standardizing, by the processor, the risk metric data by scaling each risk value in the risk metric data to a range of values for each advisor to obtain standardized risk values;
prioritizing, by the processor, the risk metric data by assigning a metric weight to the standardized risk values;
further prioritizing, by the processor, the risk metric data by assigning a category weight to the standardized risk values;
aggregating, by the processor, the risk metric data for an advisor to create advisor risk metric data;
scoring, by the processor, a risk associated with the advisor based on the advisor risk metric data; and
transferring, by the processor, the advisor risk data to a dashboard in a front-end system.

2. The method of claim 1, further comprising receiving, by the processor, a U4 Disclosures summary for the advisor as part of the risk metric data.

3. The method of claim 1, wherein the scoring includes scoring a U4 Disclosures summary of the advisor.

4. The method of claim 1, further comprising creating, by the processor, risk trends based on the risk metric data.

5. The method of claim 1, further comprising creating, by the processor, at least one of charts or graphs based on the risk metric data.

6. The method of claim 1, wherein the plurality of data sources may include at least one of input from supervisors, an Excel file, an analytics database, a consequence management database or an RDMS database.

7. The method of claim 1, wherein the determining if the risk metric data passes quality control requirements includes using software as a service (SAS) programs.

8. The method of claim 1, wherein the quality control requirements include checking for at least one of data types, column names, distinct advisor numbers or text formats.

9. The method of claim 1, wherein the quality control requirements include checking for data types, and wherein the data types include at least one of surveillance referrals, complaints, investigations, supervision or advisor financial distress indicators.

10. The method of claim 1, wherein the risk metric data includes at least one of customer complaints, disciplinary actions, U4 Disclosures history, heightened supervision, realized losses, early individual retirement account (IRA) withdrawals, loan details, netflows, surveillance referrals, distance from registered principal (RP), client to staff ratio, education notices, declining gross dealer concession (GDC), low assets, bounced checks, outside business activities, recently divorced, solo practitioner, trade corrections or compliance determination.

11. The method of claim 1, wherein the risk sub-metric data includes at least one of SPS appropriateness, annuity replacements, c-share flipping, justified sales practice complaint or investigation, partially justified sales practice complaint, unjustified sales practice complaint, annuity team education, trending heightened supervision (TH&S) education, annuity team discipline, negative net flows, bounced checks, low GDC or declined GDC.

12. The method of claim 1, further comprising storing, by the processor, the risk metric data in a server directory as SAS datasets.

13. The method of claim 1, wherein the factoring includes combining a number of complaints and a settlement amount in U.S. dollars.

13. The method of claim 1, wherein the factoring includes combining assets in U.S. dollars with years of experience.

14. The method of claim 1, wherein the weighting includes assigning a higher risk to a justified complaint.

15. The method of claim 1, wherein the weighting includes assigning a lower risk to an unjustified complaint.

16. The method of claim 1, wherein the risk metric data are part of risk categories comprising at least one of risk category, risk metric or the risk sub-metric.

17. The method of claim 1, wherein the assigning the metric weight to the standardized risk values includes multiplying the standardized risk values by the metric weight.

18. The method of claim 1, wherein the assigning the category weight to the standardized risk values includes multiplying the standardized risk values by the category weight.

19. The method of claim 1, wherein the range of values is between 0.1 and 1.1.

20. The method of claim 1, further comprising creating, by the processor, an error code, in response to the risk metric data failing the quality control requirements.
